(19) United States
(12) Patent Application Publication
(10) Pub. No.: US 2011/0072247 A1
(43) Pub. Date: Mar. 24, 2011

(54) FAST APPLICATION PROGRAMMABLE TIMERS

(75) Inventors: Hubertus Franke, Yorktown Heights, NY (US); James Xenidis, Yorktown Heights, NY (US); Terry L. Nelms, II, Atlanta, GA (US); Hollis R. Blanchard, Beaverton, OR (US)

(73) Assignee: INTERNATIONAL BUSINESS MACHINES CORPORATION, Armonk, NY (US)

(21) Appl. No.: 12/563,222

(22) Filed: Sep. 21, 2009

(51) Int. Cl. G06F 9/00

(52) U.S. Cl. 712/228; 712/220; 712/E09.001

(57) ABSTRACT

Methods, systems, and computer program products for implementing fast application programmable timers are provided. A computer program product includes a tangible storage medium readable by a processing circuit and storing instructions for execution by the processing circuit for performing a method. The method includes receiving a request to set a user accessible timer, the request received from an application thread. The user accessible timer is set in response to receiving the request, the setting including initializing a counter. The counter is decremented until an interrupt threshold has been reached. An interrupt signal is transmitted to the application thread in response to detecting that the interrupt threshold has been reached.

### BACKGROUND

This invention relates generally to processing within a computing environment, and more particularly to fast application programmable timers.

Many applications require timer facilities that allow them to perform periodic or specific timing related exception handling. There are typically three parts to achieving application level timer functionality: (1) a method for requesting or canceling a timer event; (2) a method for tracking application and system specific timer events; and (3) a method to deliver a timer event to the application and force a specified application timer handler to execute. Therefore, these timer events are usually built into the hardware architecture and the operating system is used to coordinate communication between applications and the underlying hardware timers. Because timer events are used in many applications, the implementation of the timer events, as well as the coordination of timing requests, can become complex.

### BRIEF SUMMARY

An exemplary embodiment is a computer program product for implementing fast application programmable timers in a computer system. The computer program product includes a tangible storage medium readable by a processing circuit and storing instructions for execution by the processing circuit for performing a method. The method includes receiving a request to set a user accessible timer, the request received from an application thread. The user accessible timer is set in response to receiving the request, the setting including initializing a counter. The counter is decremented until an interrupt threshold has been reached. An interrupt signal is transmitted to the application thread in response to detecting that the interrupt threshold has been reached.

Another exemplary embodiment is a computer system for implementing fast application programmable timers. The computer system includes a computer processor for executing an application thread that transmits a request to set a timer. The computer system also includes a user accessible timer in communication with the computer processor for: receiving the request; setting the user accessible timer in response to receiving the request, the setting including initializing a counter; decrementing the counter until an interrupt threshold has been reached; detecting that the counter has reached the interrupt threshold; and transmitting an interrupt signal to the application thread in response to detecting that the interrupt threshold has been reached.

A further exemplary embodiment is a computer implemented method for implementing fast application programmable timers. The method includes receiving a request to set a user accessible timer, the request received from an application thread. The user accessible timer is set in response to receiving the request, the setting including initializing a counter. The counter is decremented until an interrupt threshold has been reached. An interrupt signal is transmitted to the application thread in response to detecting that the interrupt threshold has been reached.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

Referring now to the drawings wherein like elements are numbered alike in the several FIGURES:

FIG. 1 depicts a block diagram of a system including timer circuits that may be implemented by an exemplary embodiment;

FIG. 2 depicts a block diagram of a typical embodiment of a timer implementation;

FIG. 3 depicts a block diagram of one embodiment of an application programmable timer that may be implemented by an exemplary embodiment;

FIG. 4 depicts a process flow that may be implemented by an exemplary embodiment for setting fast application programmable timers; and

FIG. 5 depicts a process flow that may be implemented by an exemplary embodiment for fast application programmable timer interrupt propagation.

### DETAILED DESCRIPTION

An exemplary embodiment of the present invention provides for fast application programmable timers.

Timer facilities serve several needs throughout a large cross section of applications. Typically, timer facilities are provided by a supervisor (the operating system) because all application timer requirements need to be consolidated to establish the next timing event. Therefore, most architectures provide for two privileged timer facilities (i.e., timer facilities are only accessible via an operating system), one for periodic timers, which is used by the operating system (OS) to issue periodic scheduling decisions, and a second timer, which provides a decrementer facility. A decrementer facility is generally understood as a counter that decrements at a specific rate, and when it reaches zero asserts and interrupt. The OS maintains all pending timer requests. These timer requests can stem from applications as well as from the OS's internals demands. In order to manage all of the potential timer events, the operating system determines the next earliest timer expiration event and programs the privileged decrementer.

OS's provide well defined software interfaces to request timer functionality and specify what functions need to be executed in the application upon timer expiration. In one typical embodiment, UNIX®, the timer functionality is provided through the POSIX® signal interface. In UNIX, two signals are provided for this purpose. The first (SIGALARM) provides a wall clock timer, and the second (SIGVTALRM) provides a virtual clock timer. These timers are requested through a system call, which specifies the time and which application function will be called. When the timer expires, the OS kernel receives a decrementer interrupt and delivers the signal through the POSIX semantics. These signals have process semantics that can be delivered to any thread executing in the application. Another timer interface known in the art is provided by Windows® OS timer functions.

The interfaces described above are suitable for low timer request rates. When the timer request rates increase and/or the number of outstanding timers increases, the increased processing required by the OS to coordinate the events can burden the OS causing a deterioration in system performance. Frequent expiration of timers can also result in significant performance overhead related to the delivery mechanism. The overhead is due to privileged code (i.e. the OS) which requires saving the problem state, verifying arguments and maintaining operating system internal data structures as it manages the timers. In addition, the requirement of privileged access to the timers by the OS reduces the flexibility and traceability of software implementations that require direct access to timers.

Emerging timer workloads (e.g., network application workloads) are increasing in complexity. It is desirable to execute these workloads in problem state (often also referred to as user-mode or application mode in contrast to kernel or supervisory mode) so that they can enjoy the maximum benefit of full protection, debugability, traceability and serviceability. Exemplary embodiments of the present invention meet this need by providing efficient low overhead timer functions that are accessible to non-privileged applications.

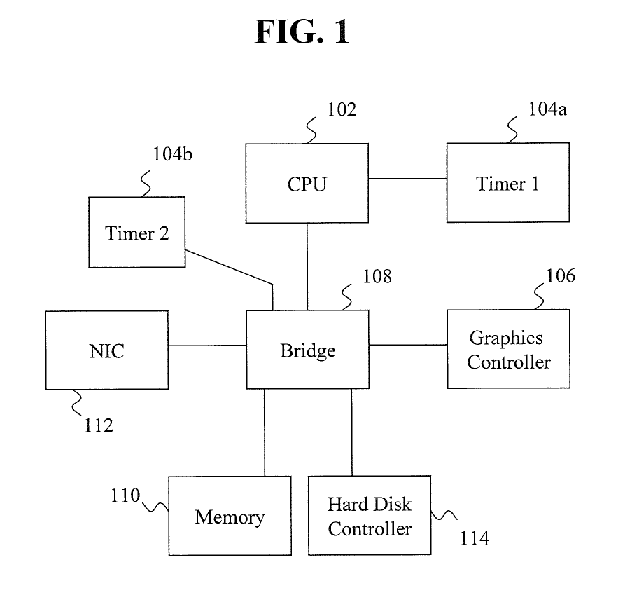

Turning now to FIG. 1, an exemplary system 100 for implementing fast application programmable timers will now be described. In an exemplary embodiment, the system 100 includes a CPU 102 executing computer instructions. The CPU 102 is connected to timer block one 104a and timer block two 104b. Timer block one 104a is an example of a timer block 104 that is directly connected to the CPU 102 and timer block two 104b is an example of a timer block 104 that is connected to the CPU 102 via the bridge 108. One or both types of timer blocks 104 may be implemented by an exemplary embodiment. In an alternate exemplary embodiment a timer block 104 is contained in the CPU 102. In an alternate exemplary embodiment, a timer block 104 contains circuits programmable for tracking system time as well as circuits for tracking time intervals as will be described in more detail below. The timer block 104 may also contain circuits for additional functionality as would be understood by those skilled in the art. The system 100 may be part of a high-speed computer processing device, such as a mainframe computer, to manage the volume of operations governed by an entity for which the fast application programmable timers are executing. In an exemplary embodiment, the system 100 is part of an enterprise (e.g., a commercial business) that implements the fast application programmable timers.

In an exemplary embodiment, the system 100 depicted in FIG. 1 includes one or more bridge systems 108 to facilitate communication between the CPU 102 and other components. The CPU 102 may, for example, communicate through the bridge system 108 to graphics controller 106 to generate video graphics. The CPU 102 may also be in communication with memory 110 through the bridge system 108. The bridge system 108 may also provide connectivity to the network interface card (NIC) 112 to facilitate communication between two or more systems over a network.

The NIC 112 may be connected (e.g., in a wireless or physical manner) to any type of known network including, but not limited to, a wide area network (WAN), a local area network (LAN), a global network (e.g., Internet), a virtual private network (VPN), and an intranet. The NIC 112 may be coupled to other systems (not shown) through multiple networks (e.g., intranet and Internet) so that not all systems are coupled to the system 100 through the same network. One or more of the other systems and the system 100 may be connected to the networks in a wireless fashion. In one exemplary embodiment, the other systems are connected directly (i.e., not through the NIC 112) to the system 100 and the system 100 contains memory 110 for storing data in support of applications which implement fast application programmable timers. Alternatively, a separate storage device may be implemented for this purpose.

The bridge system 108 connects to the hard disk controller 114. The hard disk controller 114 controls access to one or more storage devices (not shown) which may include a data repository with data relating to applications which use or implement fast application programmable timers, as well as other data/information desired by the entity representing the system 100 of FIG. 1. The storage devices may be logically addressable as a consolidated data source across a distributed environment that includes networks which are connected by the NIC 112 as described above. Information stored in the storage devices may be retrieved and manipulated via the CPU 102 and/or the other systems connected to the system 100. It will be understood by those of ordinary skill in the art that the data repository may also comprise other structures, such as an XML file on the file system or distributed over a network (e.g., the NIC 112), or from a data stream from another server located on a network.

The system 100 may also operate as an application server. The system 100 executes one or more computer programs which use the fast application programmable timers. Computer system 100 includes one or more fast application programmable timers that are implemented by the timer block 104.

It will be understood that the generation of the fast application programmable timers described in FIG. 1 may be implemented in hardware, software, or a combination thereof. Although the system 100 has been described in terms of a single processor system, it will be understood that fast application programmable timers may also be implemented in systems containing a plurality of processors and other circuits and systems described above.

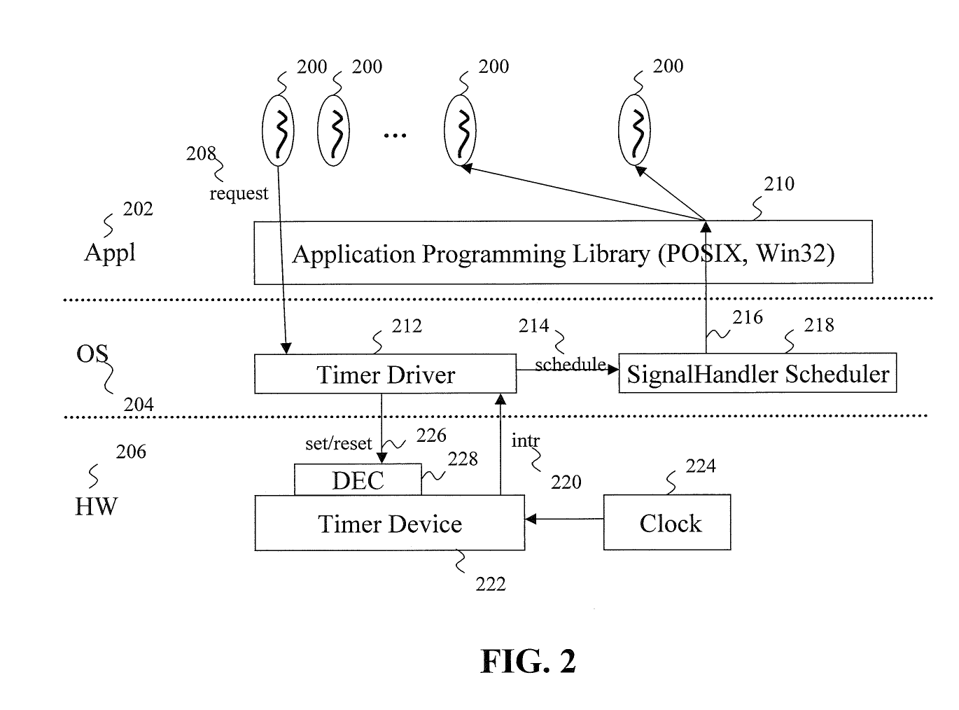

FIG. 2 is a system diagram of a typical timer that may be implemented by a computer processor. FIG. 2 is divided into three layers. The application layer 202 communicates through the OS layer 204 in order to set a timer in the hardware layer 206. The application layer 202 executes on the CPU 102 as application threads (threads) 200. These threads 200 represent concurrent process of separate applications and/or multiple parallel processes in a single application. As described above, threads 200 may require timers for various functions. One such function is a wait function, wherein an application thread 200 is required to wait for a certain amount of time. When a thread 200 is required to wait for a specified amount of time it must use the timing mechanisms that are available in the hardware layer 206. Current systems do not allow direct access to the timing mechanisms in the hardware layer 206 from the application level 202. Timer requests must be sent from the threads 200 to the application programming library (APL) 210 located in the application layer 202.

The thread 200 sends a request 208 to the APL 210. The APL 210 can then communicate directly to the OS layer 204 by forwarding the request 208 to the timer driver 212. The timer driver can then execute a set/reset command 226 to the decrementer (DEC) 228. In exemplary embodiments the DEC 228 is located within timer block 104. The set/reset command 226 contains the number from which the DEC 228 should begin decrementing. The DEC 228 is controlled by the timer device 222. The timer device 222 receives time messages from the clock 224 at regular intervals. For each time message that the timer device 222 receives from the clock 224, the DEC will decrement the value it received from the set/reset command 226 until it reaches a value (typically zero). When the DEC 228 reaches the value, the timer device 222 sends an interrupt signal 220 to the timer driver in the OS layer 204. The timer driver then sends a schedule request 214 to the signal handler scheduler 218 which sends a signal event 216 to an eligible thread 200 as specified by the original thread request to the APL 210.

As discussed above, current timer implementations require a thread 200 to communicate with the APL 210 and the OS layer 204 in order to set the timer.

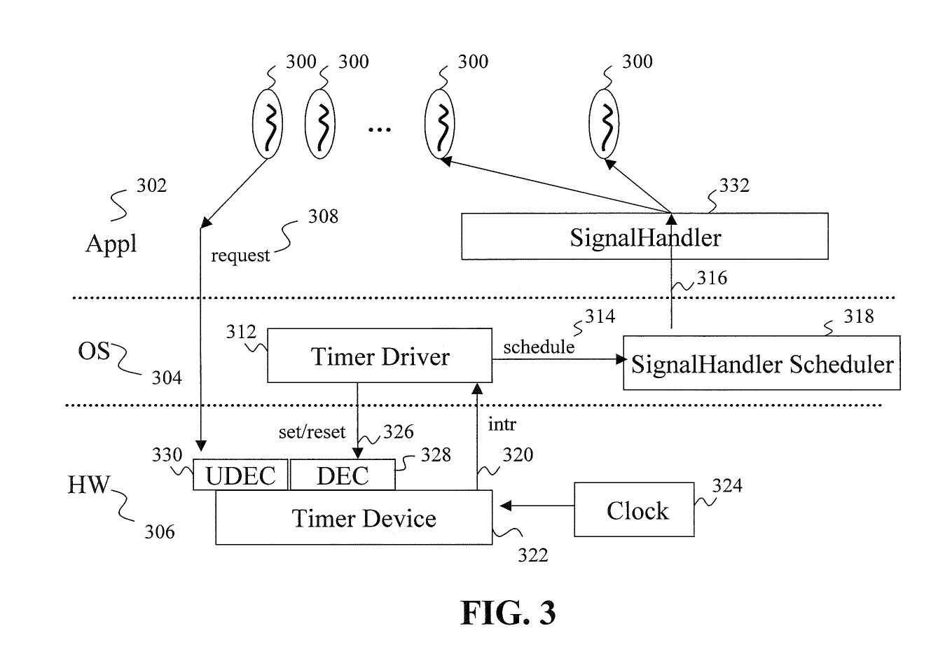

FIG. 3 depicts a system diagram of a fast application programmable timer implementation that may be implemented by an exemplary embodiment. FIG. 3 is broken up into three layers, the application layer 302, the OS layer 304 and the hardware layer 306. In an exemplary embodiment, the application layer and OS layer reside on the CPU 102, and the hardware layer resides the timer block 104. Similar to the system diagram depicted in FIG. 2, the application layer 302 executes as threads 300 on the CPU 102, and the threads 300 represent concurrent processes of separate applications and/or multiple parallel processes in a single application. Also similar to the system described in reference to FIG. 2, the threads 300 may require timers for various functions. However, as depicted in FIG. 3, application threads 300 are not required to interface with the APL 210 and the timer driver 204 to request timer events. Instead, as depicted in FIG. 3, the threads 300 may request timer events 308 directly. The timer event requests 308 are sent directly to a special purpose register that is used as a user accessible timer. The user accessible timer is shown in FIG. 3 as a user accessible decrementer (UDEC) 330 located within timer block 104.

In an exemplary embodiment, the UDEC 330 is a 64 bit register and is comprised of one or more bits that indicate whether or not the UDEC 330 is enabled. In addition, the UDEC 330 contains “N” number of bits that are designated as the counter. In exemplary embodiments the counter is 32 bits. Any unused bits in the UDEC 330 will be ignored. Although this embodiment describes a 64 bit register with 32 bits used for the counter, it will be understood by those in the art that the register, counter, and enabling bits can be of any size or configuration. The operation of the UDEC 330 will be described more fully below. In an exemplary embodiment, the UDEC 330 is controlled by the timer device 322. The timer device 322 receives time messages from the clock 324 at regular intervals. For each time message that the timer device 322 receives from the clock 324, the UDEC 330 decrements the received value from the set/reset command 326 until it reaches a value (typically zero). When the UDEC 330 reaches the value, known as the interrupt threshold, the timer device 322 sends an interrupt signal 320 to the thread 300 using one of several methods as will be described in more detail below.

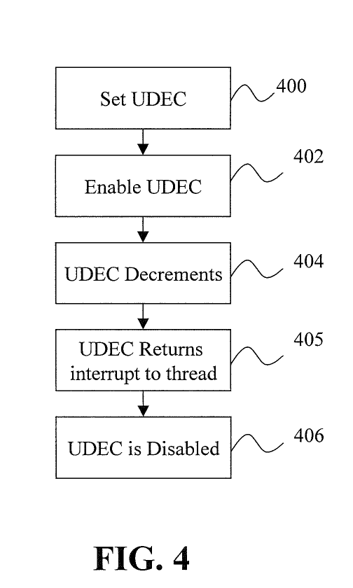

FIG. 4 is a process flow for providing fast application programmable timers that may be implemented by an exemplary embodiment. At block 400 an application thread 300 sets the counter bits of the UDEC 330. At block 402, the UDEC 330 is enabled by the application thread by setting the enabling bit. At block 404 the UDEC 330 begins to decrement the counter bits. The UDEC 330 decrements the counter bits by responding to the signal sent to it from the timer device 322 as described above. At block 406 the UDEC 330 runs the counter to a predetermined value, zero in this case, and returns an interrupt signal to the application thread 300 as described below. At block 408, the UDEC is disabled by, for example, setting the enabling bit or bits to zero.

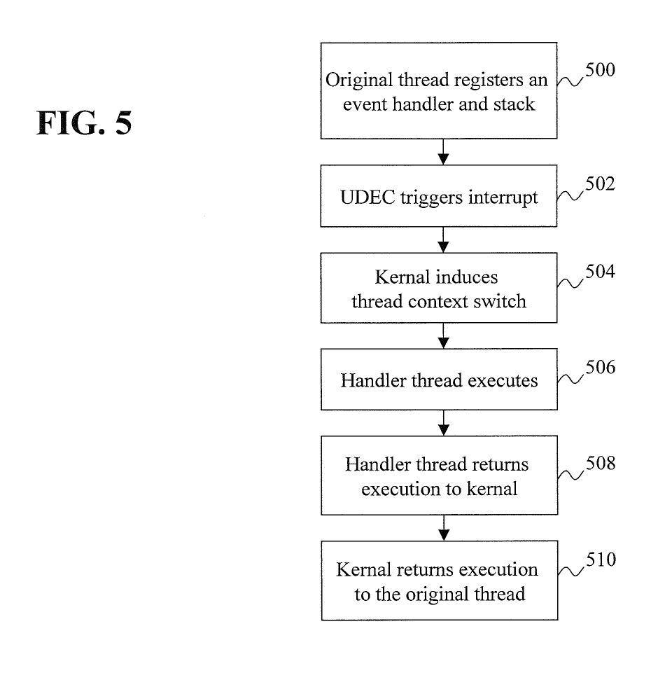

Turning to FIG. 5, a process flow for an exemplary embodiment of the interrupt return for fast application programmable timers is depicted. At block 500 one of the threads 300 (e.g., the original thread) registers an event handler thread (event handler) with the OS layer 304. The event handler is associated with a memory stack that is large enough to handle any processing that the event handler will need to handle the timer interrupt. At block 502 the UDEC 330 counter reaches zero and triggers an interrupt. At block 504 the OS layer 304 kernel induces a thread context switch. This switches execution from the current thread, the original thread for example, to the exception handler. At block 506, the exception handler that was registered at block 500 executes in response to the interrupt signal passed to it from the UDEC 330. At block 508, the exception handler completes execution and returns processing to the kernel. At block 510 the kernel switches execution back to the original thread which then continues executing normally.

In an alternative exemplary embodiment for returning the interrupt to the original thread, the UDEC is set as described above. Once the UDEC 330 counter reaches zero, it triggers an interrupt. The interrupt is then routed through the timer driver 312 and the signal handler scheduler 318, which passes the interrupt to the signal handler 332. The signal handler 332 then delivers the timer expiration associated with the interrupt as a signal back to the original thread in the normal fashion.

In yet another alternative exemplary embodiment for returning the interrupt to the original thread, the UDEC 330 delivers the interrupt directly to the application layer 302 by first saving the problem state instruction pointer in an additional, user owned, special purpose register. The OS layer 304 then jumps processing to a preregistered application instruction address. After allowing the application to handle the timer interrupt, the application returns by branching through this special purpose register. In this exemplary embodiment, an additional branch instruction might be required.

In another exemplary embodiment of the fast application programmable timers, the UDEC 330 is disabled by the application thread 300 before the interrupt signal is triggered. In this case, the application thread 300 sets the timer as described above. At some point after the timer is set, but before the timer reaches zero, the application thread 300 no longer requires the use of the timer. The application thread 300 then sets the enabled bits to indicate that the UDEC 330 is disabled. This can be accomplished, for example, by setting the enabling bit or bits to zero.

In yet another exemplary embodiment of the fast application programmable timers, the UDEC 330 is coded to provide security at the application level. The security mechanism prevents all applications from setting the UDEC 330 unless they have permission. This can be accomplished by having application level privileges associated with accessing particular registers that are managed as part of the application state. To request permission, the application needs to be granted access by the OS and any access to the UDEC register by the application must first be permitted by the OS. If no permissions are granted the access are intercepted and an illegal instruction or illegal access exception is asserted.

In an alternate embodiment, the counter is set based on a time that is relative to some time value in the past (e.g. to a timestamp inserted by NIC 112). The timer calculates the value in the UDEC by using a relative value based on an offset between the time value and the current time.

In another exemplary embodiment, the UDEC 330 is enabled for an application thread and then the application thread is descheduled. In this case the OS 304 converts the remainder of the UDEC 330 counter into a supervisor/kernel internal timer structure that is handled by the DEC 328 infrastructure. Upon reschedule of the application thread, the remainder of the time is reprogrammed into the UDEC 330. Should the timer associated with the UDEC expire, that is the kernel timer associated with the UDEC expired, the event is delivered as before and the thread is scheduled.

Technical effects and benefits include user state programmable timers. The additional flexibility of allowing users to set and maintain their own timers represents various benefits. Application programmable timers allow faster access to the timers by applications by eliminating the overhead generally associated with the operating system invocation. In addition, direct access to the timers allows application developers to control and debug their programs more efficiently.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As described above, embodiments can be embodied in the form of computer-implemented processes and apparatuses for practicing those processes. In exemplary embodiments, the invention is embodied in computer program code executed by one or more network elements. Embodiments include a computer program product on a computer usable medium with computer program code logic containing instructions embodied in tangible media as an article of manufacture. Exemplary articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the invention. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the invention. When implemented on a general-purpose microprocessor, the computer program code logic segments configure the microprocessor to create specific logic circuits.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A computer program product for implementing fast application programmable timers in a computer system, the computer program product comprising:
a tangible storage medium readable by a processing circuit and storing instructions for execution by the processing circuit for performing a method comprising:
receiving a request to set a user accessible timer, the request received from an application thread;
setting the user accessible timer in response to receiving the request, the setting including initializing a counter;
decrementing the counter until an interrupt threshold has been reached;
detecting that the counter has reached the interrupt threshold; and
transmitting an interrupt signal to the application thread in response to detecting that the interrupt threshold has been reached.

2. The computer program product of claim 1, wherein the user accessible timer is halted before the interrupt threshold is reached.

3. The computer program product of claim 1, wherein the application thread sets an event handler thread, the event handler thread receiving the transmitted interrupt signal.

4. The computer program product of claim 3, wherein the method further comprises:
receiving the interrupt signal;
inducing a thread context switch to the event handler thread;
executing the event handler thread; and
returning execution to the application thread.

5. The computer program product of claim 1, wherein the user accessible timer is only accessible to a limited number of application threads.

6. The computer program product of claim 1, wherein the request is received directly from the application thread at a user accessible timer.

7. The computer program product of claim 1, wherein the user accessible timer transmits the interrupt signal directly to the application thread.

8. A computer system for implementing fast application programmable timers, the computer system comprising:
a computer processor for executing an application thread, the application thread transmitting a request to set a timer; and
a user accessible timer in communication with the computer processor for:
receiving the request;
setting the user accessible timer in response to receiving the request, the setting including initializing a counter;
decrementing the counter until an interrupt threshold has been reached;
detecting that the counter has reached the interrupt threshold; and
transmitting an interrupt signal to the application thread in response to detecting that the interrupt threshold has been reached.

9. The computer system of claim 8, wherein the user accessible timer is halted before the interrupt threshold is reached.

10. The computer system of claim 8, wherein the application thread sets an event handler thread for receiving the interrupt signal.

11. The computer system of claim 10, wherein the computer system further comprises an operating system OS kernel for:
receiving the interrupt signal;
inducing a thread context switch to the event handler thread;
executing the event handler thread; and
returning execution to the application thread.

12. The computer system of claim 8, wherein the user accessible timer is only accessible to a limited number of application threads.

13. The computer system of claim 8, wherein the application thread transmits the request to set the timer directly to the user accessible timer.

14. The computer system of claim 8, wherein the user accessible timer transmits the interrupt signal directly to the application thread.

15. A computer implemented method for implementing fast application programmable timers, the method comprising:
receiving a request to set a user accessible timer, the request received from an application thread;
setting the user accessible timer in response to receiving the request, the setting including initializing a counter;
decrementing the counter until an interrupt threshold has been reached;
detecting that the counter has reached the interrupt threshold; and
transmitting an interrupt signal to the application thread in response to detecting that the interrupt threshold has been reached.

16. The computer implemented method of claim 15, wherein the user accessible timer is halted before the interrupt threshold is reached.

17. The computer implemented method of claim 15, wherein the application thread sets an event handler thread, the event handler thread receiving the transmitted interrupt signal.

18. The computer implemented method of claim 17, further comprising:
receiving the interrupt signal;
inducing a thread context switch to the event handler thread;
executing the event handler thread; and
returning execution to the application thread.

19. The computer implemented method of claim 15, wherein the user accessible timer is only accessible to a limited number of application threads.

20. The computer implemented method of claim 15, wherein the request is received directly from the application thread at a user accessible timer.
